(19) United States
(12) Patent Application Publication
(10) Pub. No.: US 2022/0176232 A1
(43) Pub. Date: Jun. 9, 2022

(54) See It Say It Know It Multiplication Tables

(71) Applicant: Cynthia Theresa Crocker, Philadelphia, PA (US)

(72) Inventor: Cynthia Theresa Crocker, Philadelphia, PA (US)

(21) Appl. No.: 17/564,711

(22) Filed: Dec. 29, 2021

Related U.S. Application Data
(63) Continuation-in-part of application No. 16/368,023, filed on Mar. 28, 2019, now abandoned.
Application No. 16/368,023 is a continuation-in-part of application No. 15/263,211, filed on Sep. 12, 2016, now abandoned.
(60) Provisional application No. 62/217,853, filed on Sep. 12, 2015.

(51) Int. Cl. A63F 3/04

(52) U.S. Cl. CPC A63F 3/0415; A63F 2003/00523; A63F 2003/046; A63F 3/0457

(57) ABSTRACT

The mechanics of See It Say It Know It Multiplication Tables involve moving pieces around a large board and discovering the product or answers by uncovering the multiplicand with dice rolls.

It is a game board kit, including twelve individual game boards, each game board configured to resemble the shape of or depict a number 1-12, known as a multiplier. Each number 1-12 has a corresponding (colored-coded) game board, with twelve numbers arranged on each game board. Also, the twelve numbers on each game board correspond to a product of a multiplier, which is a number 1-12 and is the multiplicand of the respective game board.

And twelve (color-coded) disks, each disk depicting one of a number corresponding to 1-12 and configured to cover one of the 12 numbers arranged on each game board.

### CROSS-REFERENCE TO RELATED APPLICATION

The applicant claims the benefit, U.S. patent application Ser. No. 16/368023 filed Mar. 28, 2019, which claims the benefit of U.S. patent application Ser. No. 15/263211, filed Mar. 28, 2019, which claims the benefit of the U.S. Provisional App. No. 62/217853, filed Sep. 12, 2015. The Applicant hereby claims the benefit of each of these prior U.S. provisional and nonprovisional patent applications. The entire content of each of these prior U.S. provisional and nonprovisional applications is incorporated herein by this reference.

### FIELD OF THE INVENTION

The present invention relates to apparatus and methods for training children in multiplication. Children acquire the knowledge utilizing a board game or puzzle.

### BACKGROUND OF THE INVENTION

Teaching the multiplication table has traditionally been performed by rote verbal memory drills or repeatedly written multiplication facts as a homework assignment. Perhaps better to utilize a method associated with amusement and games, relying upon sight (memorization) for learning (rather than relying on auditory input or tedious mundane, written exercises).

### SUMMARY OF THE INVENTION

The present invention provides a method of instructing young learners in multiplication tables employing a nonintrusive game or game-like atmosphere. When practiced as an academic exercise, an authority such as a teacher leads the queries requiring students to respond en masse with answers to individual multiplication queries. However, following the rules of the game, it enables the learner to master the multiplication tables because of frequent play. Afterward, the teacher may transfer (student learning) from the concrete to the abstract (using a Smartboard or Opaque Projector). Also, introducing the Math terminology, multiplier, multiplicand, and product. An option for the teacher is to include the chant: “We go to (Name of School), We come here to learn, and if we get this Math, Big Bucks we can earn!”

Children recall basic multiplication tables based on sight recognition and rely upon sight (memorization) for learning (rather than relying on auditory input or tedious mundane, written exercises).

### BRIEF DESCRIPTION OF THE DRAWINGS

FIG. 1 illustrates (100) a standardized 15×15 Gameboard.

FIG. 1A) illustrates an alternative standardized vinyl plastic Gameboard.

FIG. 2 illustrates a configuration of numerical table 1.

FIG. 2A illustrates twelve circular disks to cover the products 1-12.

FIG. 3 illustrates a dodecahedron (twelve-sided) dice.

FIG. 4 illustrates a configuration of numerical table 2.

FIG. 5 illustrates a configuration of numerical table 3.

FIG. 6 illustrates a configuration of numerical table 4.

FIG. 7 illustrates a configuration of numerical table 5.

FIG. 8 illustrates a configuration of numerical table 6.

FIG. 9 illustrates a configuration of numerical table 7.

FIG. 10 illustrates a configuration of numerical table 8.

FIG. 11 illustrates a configuration of numerical table 9.

FIG. 12 illustrates a configuration of numerical table 10.

FIG. 13 illustrates a configuration of numerical table 11.

FIG. 14 illustrates a configuration of numerical table 12.

FIG. 15 illustrates a SmartBoard or Classroom Blackboard.

FIG. 16 illustrates a 2×13 horizontal array.

FIG. 17 illustrates three 2×13 vertical arrays.

FIG. 18 illustrates three 2×13 vertical arrays.

### DETAILED DESCRIPTION

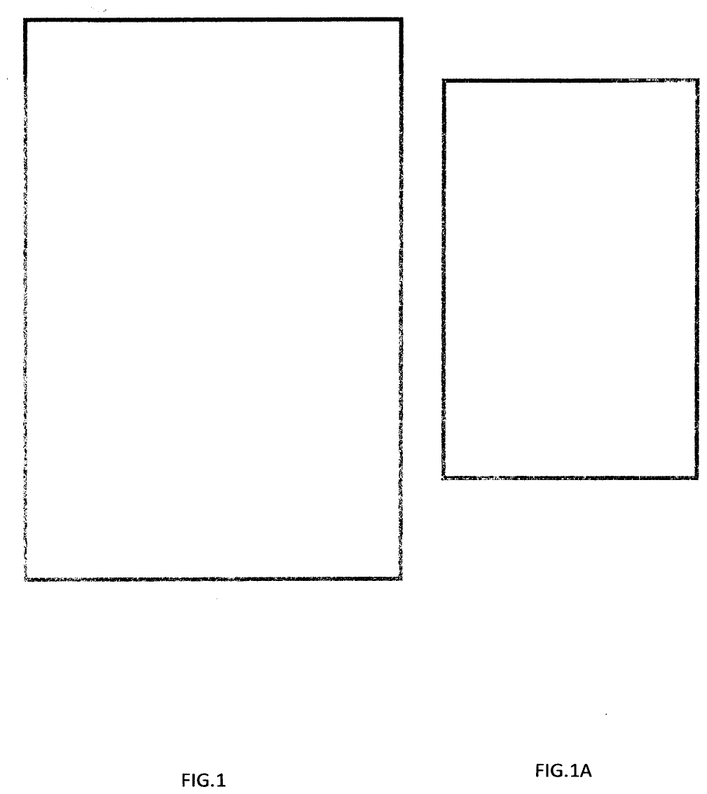

The See It, Say It, Know It, Multiplication Game comprises of FIG. 1, illustrates a standard (100) 15″×15″ sturdy cardboard (or (100A) a foldable vinyl game board) with the numeral configuration representation of each number 1-12. And on each board is (102) a circular figure of the products it represents for the numeral 1-12, and (103) the multiplication symbol denoted the method of operation (printed on the figure). Each board has (104) twelve (matching) color-coded disks (the multiplicand) to cover the (102) products for 1-12. Also, there are 12 sets (144) color-coded circular disks (104) to cover the products printed onto the game board. The (100) game board is a standard cardboard, or (100A) a plastic vinyl foldable game board. Also, there is a dodecahedron (twelve-sided) dice.

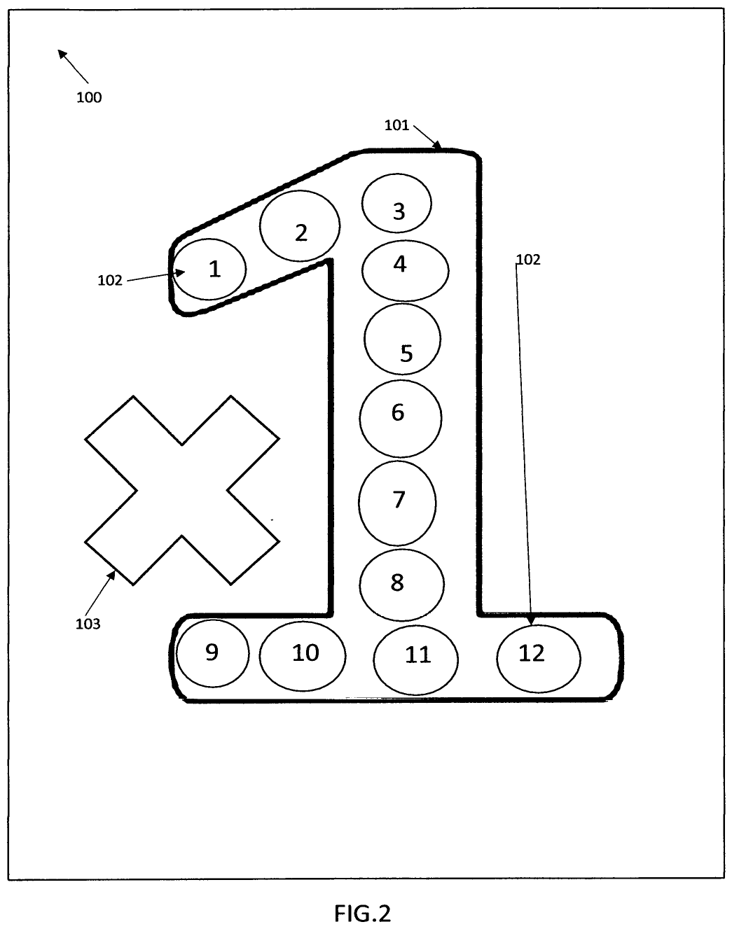

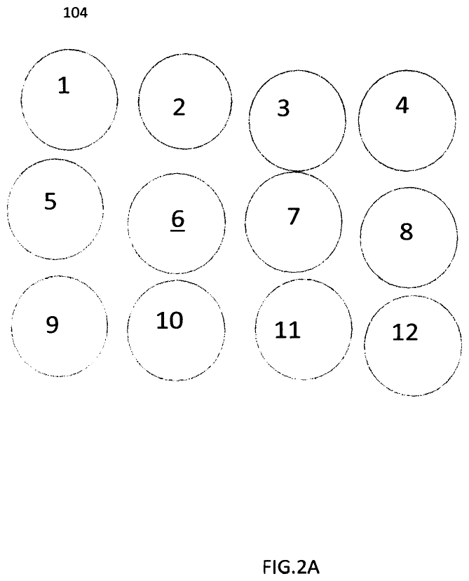

FIG. 2 illustrates FIG. 1 with the numeral configuration representation of numerical table 1-6.

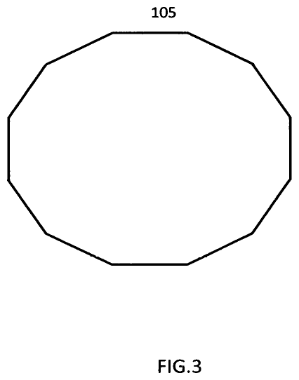

FIG. 3 is a representation of (105) a dodecahedron (twelve-sided dice. The roll of the dice determines which (104) multiplicand to remove to reveal (102) the product and replace it. Also, if the game is played with another person, the roll of (105) the die is used to determine who is first in the play. The person with the higher number goes first.

Ans s/he can roll again and lift or slide (104) multiplicand to reveal or recover (102) the product.

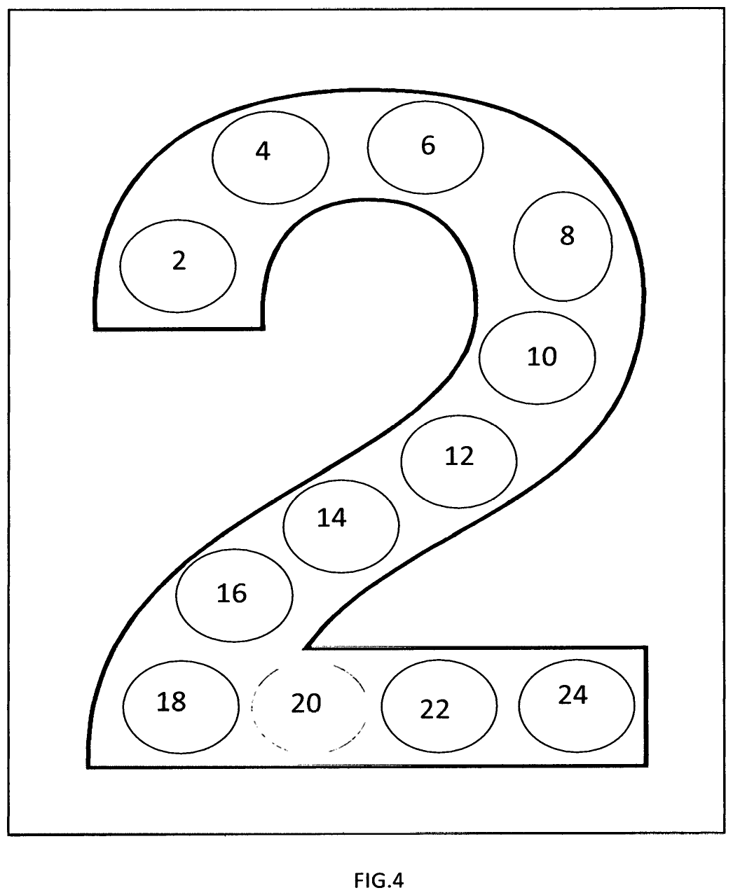

FIG. 4 is a standard 15×15 game board (or a foldable vinyl apparatus) with the numeral configuration representation of the two-multiplication table. Also (printed onto the game board) on the shaped numeral 2 are the products for the multiplicands 1-12 and the multiplication symbol.

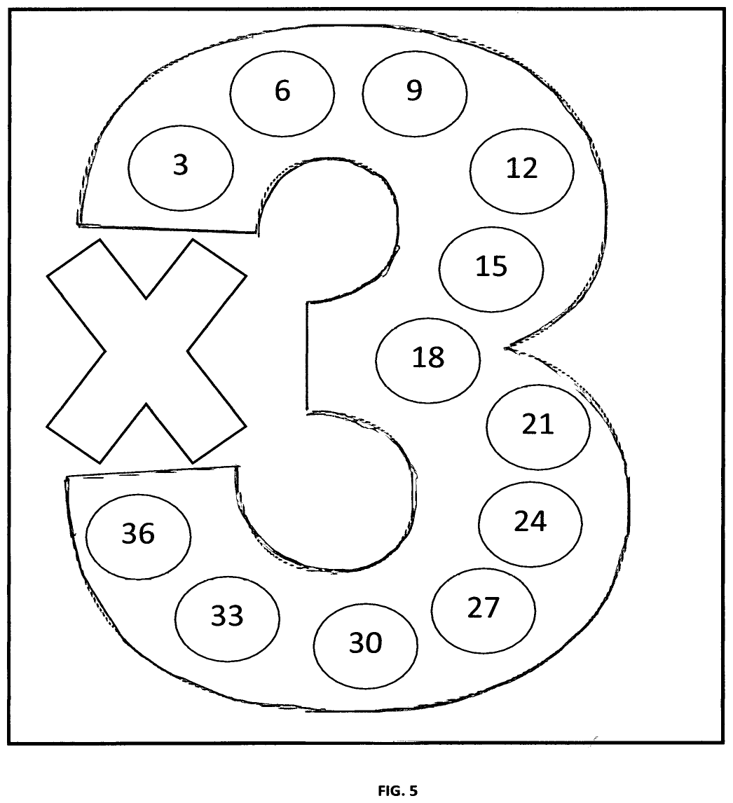

FIG. 5 is a standard 15×15 game board (or a foldable vinyl apparatus) with the numeral configuration representation of the three-multiplication table. Also, (printed onto the game board) on the shaped numeral 3 are the products for the multiplicands 1-12 and the multiplication symbol.

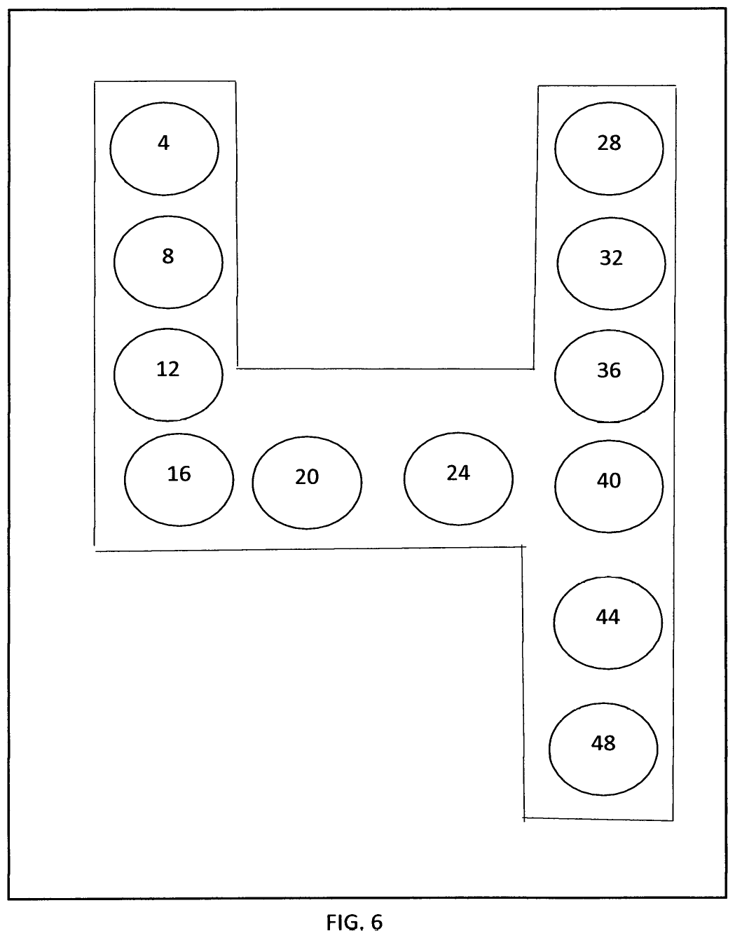

FIG. 6 is a standard 15×15 game board (or a foldable vinyl apparatus) with the numeral configuration representation of the four-multiplication table. Also (printed onto the game board) on the shaped numeral 4 are the products for the multiplicands 1-12 and the multiplication symbol.

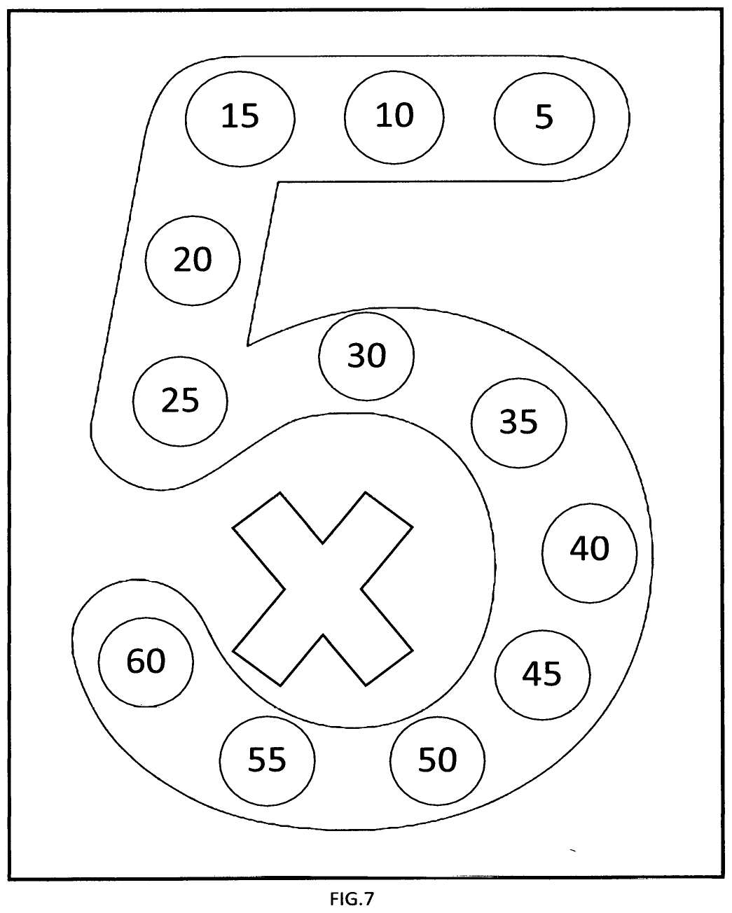

FIG. 7 is a standard 15×15 game board (or a foldable vinyl apparatus) with the numeral configuration representation of the five-multiplication table. Also (printed onto the game board) on the shaped numeral 5 are the products for the multiplicands 1-12 and the multiplication symbol.

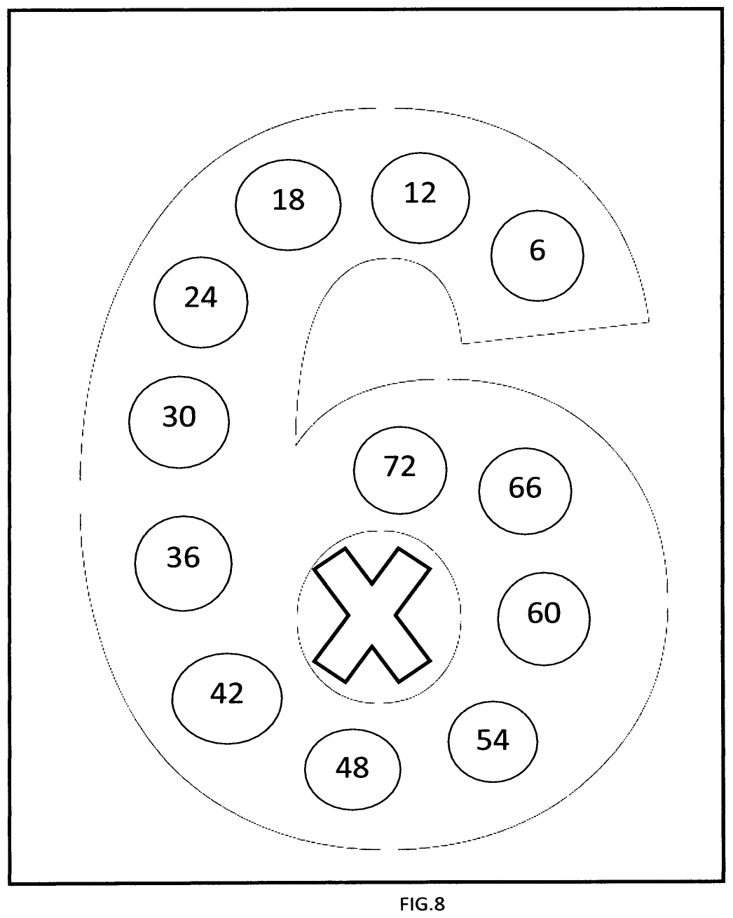

FIG. 8 is a standard 15×15 game board (or a foldable vinyl apparatus) with the numeral configuration representation of the six-multiplication table. Also (printed onto the game board) on the shaped numeral 6 are the products for the multiplicands 1-12 and the multiplication symbol.

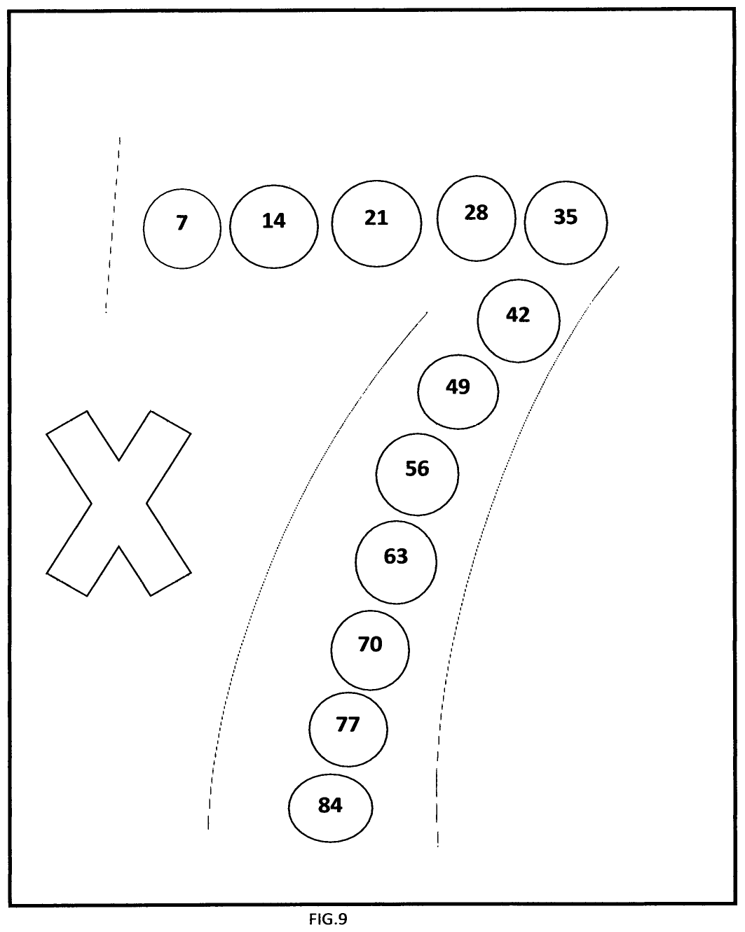

FIG. 9 is a standard 15×15 game board (or a foldable vinyl apparatus) with the numeral configuration representation of the seven-multiplication table. Also (printed onto the game board) on the shaped numeral 7 are the products for the multiplicands 1-12 and the multiplication symbol.

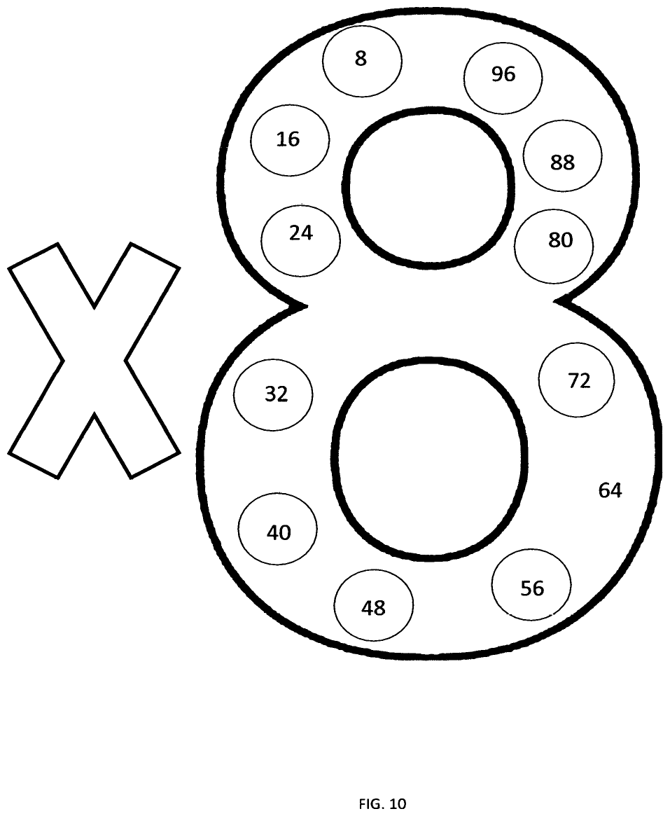

FIG. 10 is a standard 15×15 game board (or a foldable vinyl apparatus) with the numeral configuration representation of the eight-multiplication table. Also (printed onto the game board) on the shaped numeral 8 are the products for the multiplicands 1-12 and the multiplication symbol.

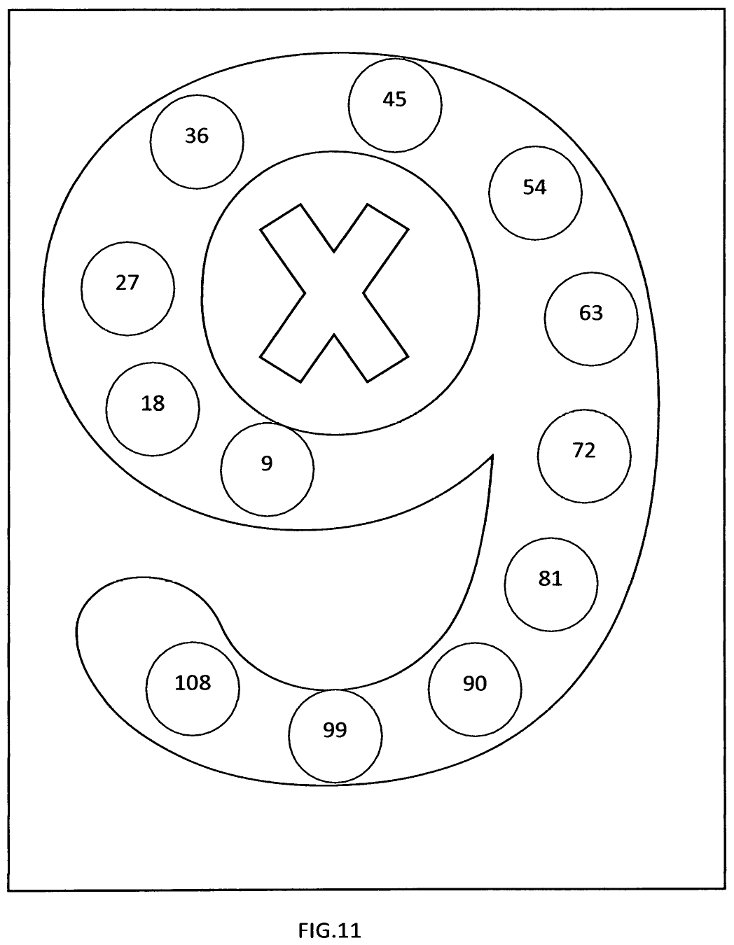

FIG. 11 is a standard 15×15 game board (or a foldable vinyl apparatus) with the numeral configuration representation of the nine-multiplication table. Also (printed onto the game board) on the shaped numeral 9 are the products for the multiplicands 1-12 and the multiplication symbol.

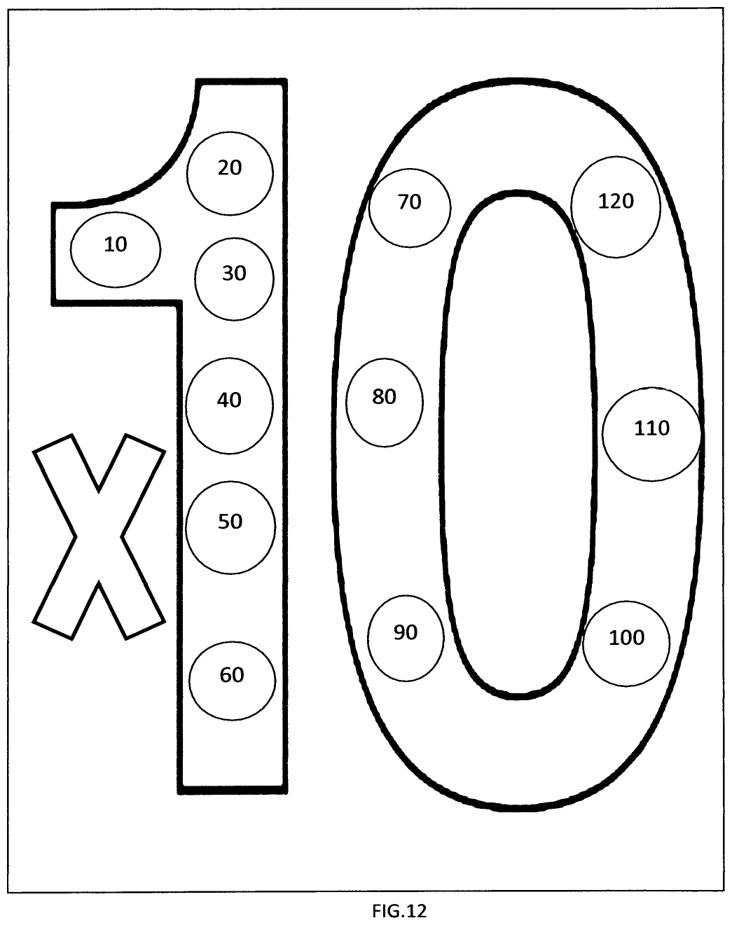

FIG. 12 is a standard 15×15 game board (or a foldable vinyl apparatus) with the numeral configuration representation of the ten-multiplication table. Also (printed onto the game board) on the shaped numeral 10 are the products for the multiplicands 1-12 and the multiplication symbol.

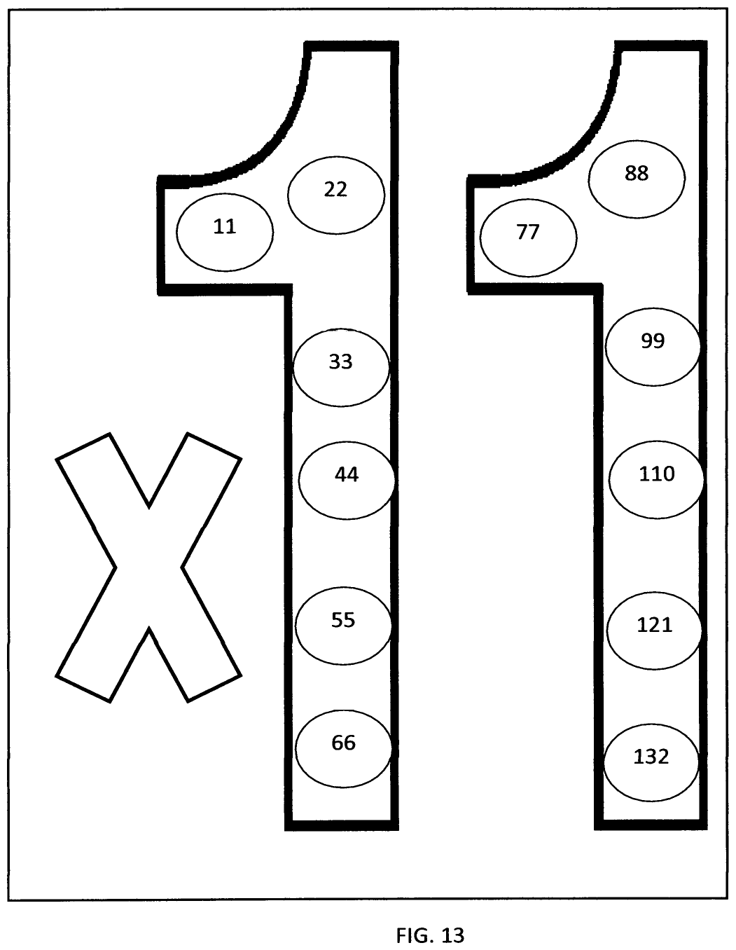

FIG. 13 is a standard 15×15 game board (or a foldable vinyl apparatus) with the numeral configuration representation of the eleven multiplication table. Also (printed onto the game board) on the shaped numeral 11 are the products for the multiplicands 1-12 and the multiplication symbol.

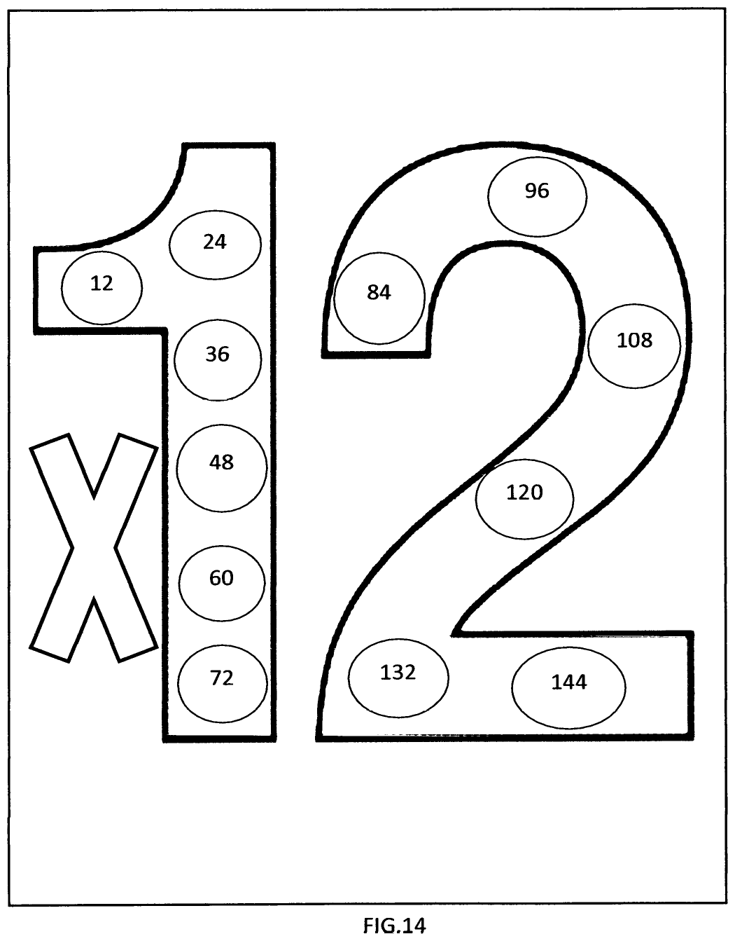

FIG. 14 is a standard 15×15 game board (or a foldable vinyl apparatus) with the numeral configuration representation of the twelve-multiplication table. Also (printed onto the game board) on the shaped numeral 12 are the products for the multiplicands 1-12 and the multiplication symbol.

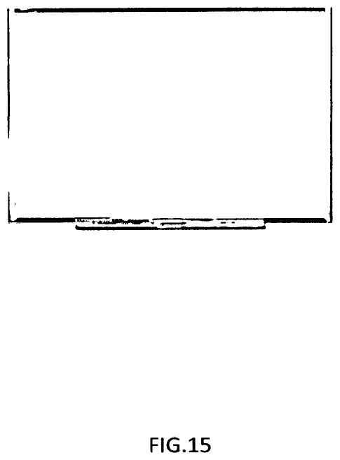

FIG. 15 is a representation of a Classroom Blackboard or a SmartBoard on which the teacher uses to display a two-tiered rectangular 2×13 array (instructional aide).

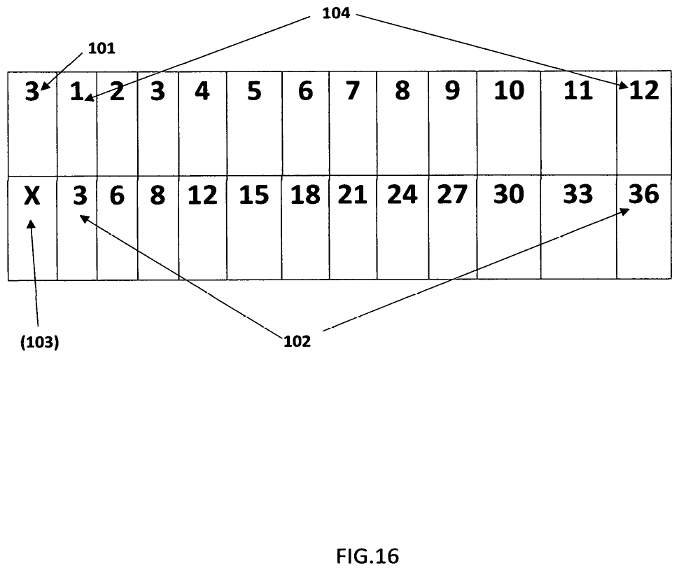

FIG. 16 illustrates a two-tiered rectangular 2×13 array (instructional aide) to accompany the Multiplication Chant: “We go to (Name of School), We come here to learn, and if we get this Math, Big bucks we can earn!.” The top row has (101) the multiplier and (104) the twelve multiplicands. The bottom row has (103) the multiplication symbol and (102) the twelve corresponding answers to the multiplier.

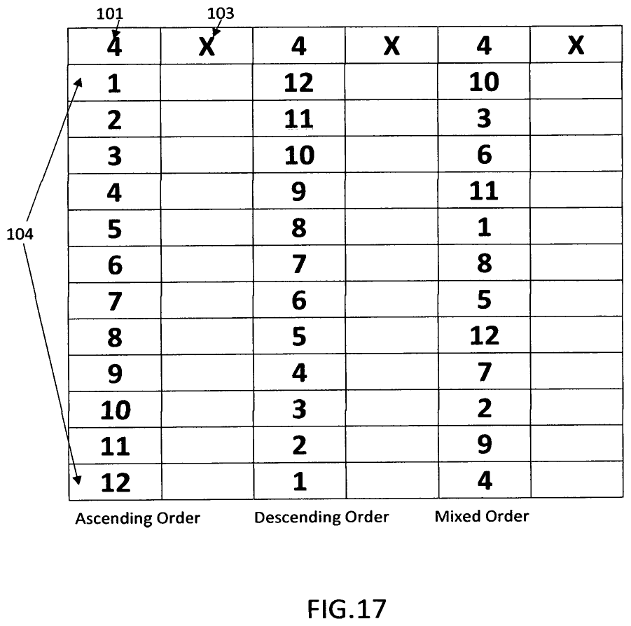

FIG. 17. illustrates a teacher-made device to test students' knowledge of the multiplication table. The three column 2×13 array can be vertically or horizontally. And ascending, descending, and mixed order.

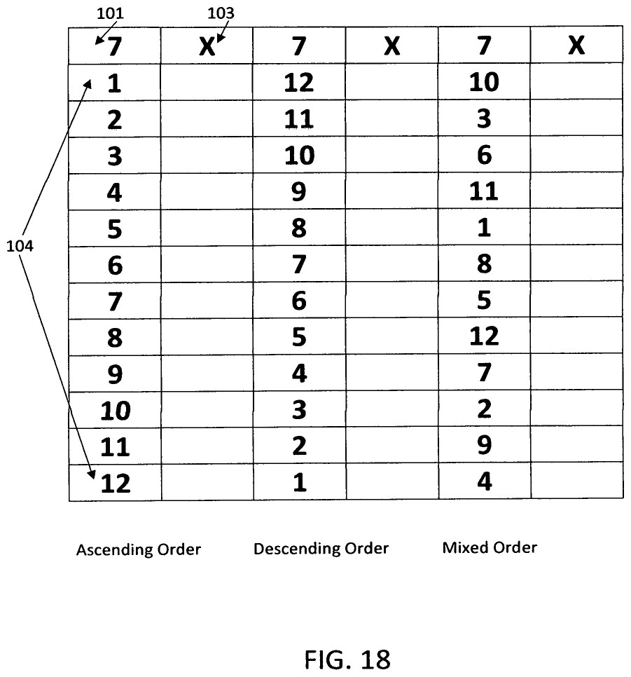

FIG. 18 is optional. It can represent a copy of an assessment tool used to determine knowledge. The assessment tool has a set time of sixty seconds, thirty seconds, and fifteen seconds. A student has mastered the multiplication table if s/he can complete the table in fifteen seconds. And the answers are 100% correct.

The configuration of the teacher-made assessment tool is incremented in 60, 30, and 15 seconds. The teacher and students know s/he has obtained proficiency when s/he can answer the twelve multiplication facts (in ascending, descending, or mixed order) in fifteen seconds.

See It Say It Know It Multiplication Games is a student-friendly multiplication game that requires, 12 game boards, twelve sets of multiplicand disks (144), one dodecahedron (Twelve-sided) die.

Teaching and learning should be fun. Learning the multiplication tables has been quite tedious, especially if they dread or fear learning math. See It Say It Know It Tables is an answer to the tables' Phobia's nightmare. There is no Drill Kill or humdrum reaction. It is a fun way to learn the multiplication tables using sight memorization instead of a time-consuming drill kill. Individuals play the game and retain the information inadvertently.

Mostly, the teaching aids in classrooms should be student-driven and not teacher-led activities. Children enjoyed using the instructional aids or Anchor Charts that are conducive to learning and children friendly. A child becomes overwhelmed if given too much information to retain. A child or children (temporarily) should be able to call an unknown object a “what-cha-ma call it! They become confused when bombarded with too much terminology, vocabulary, or concepts. Also, it hinders their problem-solving ability because they are stuck on word terms that are taunting. Mathematics (for some) is not a favorite subject, and I created the See It, Say It, Know It, Multiplication Timetables Game because I wanted students to feel comfortable learning the multiplication tables. Children need a clearer understanding of the concrete subject matter before transitioning to the abstract. Creating the game without using the terminology: multiplier, multiplicand, and product, they learned the multiplication table while playing the game. For example, if you are learning the four table, the game board is shaped like the numeral four. Each multiplication product of the four tables is printed (on the game board). The circular disk numbered 1-12 (the multiplicand) covers each product. The game board and the disks are color-coded. The student cannot confuse the four times table with another multiplication table because of the color-coded aspect of the game. S/he memorizes which colored gameboard and which color-coded disk was correlated (or matched). Further differentiated (and retaining) the multiplication facts because of the difference in coloring. The student rolls the dice to view/uncover the hidden product (then replace it), and the student is learning multiplication tables by sight recognition. Students are (later) introduced to the vocabulary words: multiplier, multiplicand, and product (or answer).

And as previously stated, the child or children surmise or guess the circular disks must be the multiplicand, because he knows what a gameboard is, and he knows what a set of dice looks like.

For students who have played the multiplication table game for a while, a parent or instructor can select one of the multiplication board games and have the student cover the board. Students can (or after much practice) answer the twelve covered multiplication facts. The student cannot see the product, but s/he can answer because s/he remembers what is under the covered number disks. A student learns the multiplication table not subjected to Drill overkill, but s/he played a (fun to do) game. The students (later) learn what each figure represents: figure four is the multiplier, the circled disks printed on the number four is the product or answer, and the disks on the top (covering the product) is the multiplicand). The advantage of using the See It Say It Know It Board Game, the learner views with the naked eye and then stores the information in the brain for easy recall if needed.

The instructions for the game are as follows: Individual, roll the dice, uncover the disk representing the number rolled and replace it. If there are two students, then each player will roll the die to determine who is first. Gradually, student(s) can recall the answer hidden beneath without removing the multiplicand. Students are given the multiplication terminology after playing the game for a while. This allows the students to make connections with the multiplication table game previously played.

### Rules See it Say it Know it Multiplication Game:

The object of the game is to learn the multiplication tables by sight memorization. Children will remember the multiplication facts by remembering the hidden product. Students should work in pairs (or can work independently).

Step 1: Children will remove one multiplication board from the kit, twelve matching circular disks to place on top of (102) the products, and one twelve-sided dice, and cover (100) the multiplication Board with (104) the numbered disks 1-12.

Step 2: Children roll (105) the dodecahedron dice to see who goes first.

Step 3: The player with the highest number goes first. The game ends when all the numbers are removed. Students count the number of disks gathered to determine the winner. If each child collects six disks, students will roll die to determine the winner. The highest number wins the round.

### Rules for School: Follow Steps 1-3.

Step 4: Students will play as many rounds as time permits or indicated by the teacher. The teacher instructs students to practice for a set time to review their multiplication table (before the actual game begins).

Step 5: Students will roll the dice, uncover the product (answer) and then recover the product. Once the set time (for practicing) is over, the teacher then instructs students to begin the multiplication challenge.

### Whole-Class Instruction:

Multiplication Chant: “We go to “Name of School”; We come here to learn; And if we get this Math; Big Bucks we can earn.” The teacher reproduces the multiplication Chart as shown below on Blackboard or Smartboard (FIG. 15).

A teacher using a pointer point to the factor. Students orally respond by saying the product. The teacher points in numerical order frontwards and backward, then randomly as s/he feels students are confident in echoing the correct response. (The teacher should say to the student, “What do you see? (Pointing to the (multiplicand), then “What do you say?” (Pointing to the product). hereafter, the teacher begins the chant and then points only to the multiplicand. The students have had enough practice to respond with the correct product. Children will remember the multiplication facts by remembering the hidden product) on the game board.

Students should work in pairs (or can work independently).

Step 1: Children will cover the multiplication Board (the multiplier) with the disks (multiplicand) numbered 1-12.

Step 2: Children will roll die to see who is first.

Step 3: The player with the highest number is first. All uncovered numbers end the game (round). Students count the number of disks gathered to determine the winner. If each child collects six chips, students will roll die to determine the winner. The highest number wins the round.

### Rules for School: Follow Steps 1-3.

Step 4: Students will play as many rounds as time permits or indicated by the teacher. The teacher instructs students to practice for a set time to review their multiplication table(before the actual game begins).

Step 5: Students will roll the dice, uncover the product (answer) and then recover the product. Once the set time (for practicing) is over, the teacher then instructs students to begin the multiplication challenge.

### Whole-Class Instruction:

Multiplication Chant: “We go to “Name of School”; We come here to learn; And if we get this Math; Big Bucks we can earn.” The teacher reproduces the multiplication Chart as shown below on Blackboard or Smartboard (FIG. 5).

A teacher using a pointer point to the factor. Students orally respond by saying the product. The teacher points in numerical order frontwards and backward, then randomly as s/he feels students are confident in echoing the correct response.

(The teacher (pointing to the multiplicand) says to the student, “What do you see?

(The teacher (pointing to the product) says, “what do you say?”

The teacher says the chant only, then the teacher points to the multiplicand.

The students have had enough practice to respond with the correct product.

If a child knows its numbers from 1-50, s/he can also learn the multiplication tables using this game. Also, this game can be transformed into a puzzle. The puzzle pieces are arrayed to shape the multiplier. The product is printed onto the puzzle frame. The multiplicand is printed on the top of the removable puzzle piece. Each piece is specifically cut to fit its correlating product well embedded on the master frame.

S/he is learning to recognize the numerals 1-12, and the corresponding products.

I claim:

1. A game board kit, comprising:
twelve individual game boards, each game board configured to resemble the shape of or depict a number 1-12, known as a multiplicand, wherein each number 1-12 has a corresponding game board;
twelve numbers arranged on each game board, wherein the twelve numbers on each game board each correspond to a product of a multiplier, which is a number 1-12, and the multiplicand of the respective game board: and
twelve disks, each disk depicting one of a number corresponding to 1-12 and configured to cover one of the 12 numbers arranged on each game board.

2. The game board kit according to claim 1, further comprises a twelve-sided die to determine which number to uncover to reveal the product.

3. The game board kit according to claim 1, wherein the 12 numbers arranged on each game board are each depicted inside a respective disc shape on the game board.

4. The game board kicked according to claim 1, wherein each game board is configured as a puzzle.

5. A method of learning multiplication tables comprising the steps of:
a) providing the game for kids of claim 1;
b) rolling a die to select a number from 1 to 12;
c) removing a disc that has the same number as selected by rolling the die from one of the 12 game boards and exposing the product number underneath the disk;
d) repeating steps b) and c) multiple times whereby a student can memorize the product numbers associated with each multiplicand and multiplier.
